(19) United States
(12) Patent Application Publication
(10) Pub. No.: US 2021/0090030 A1
(43) Pub. Date: Mar. 25, 2021

(54) INFORMATION PROCESSING APPARATUS, NON-TRANSITORY COMPUTER-READABLE MEDIUM, AND TIME PERIOD DESIGNATION SYSTEM

(71) Applicant: TOSHIBA TEC KABUSHIKI KAISHA, Tokyo (JP)

(72) Inventor: Toshiyuki FUJII, Mishima Shizuoka (JP)

(21) Appl. No.: 17/019,882

(22) Filed: Sep. 14, 2020

(30) Foreign Application Priority Data
Sep. 24, 2019 (JP) 2019-173374

(51) Int. Cl. G06Q 10/10

(52) U.S. Cl. CPC G06Q 10/1093

(57) ABSTRACT

According to one or more embodiments, an information processing apparatus includes a processor that displays a first calendar and a second calendar. The processor accepts an operation for designating, as an end date, a date which passes at least three months from a start date designated in the first calendar or the second calendar.

### CROSS-REFERENCE TO RELATED APPLICATIONS

This application is based upon and claims the benefit of priority from Japanese Patent Application No. 2019-173374, filed on Sep. 24, 2019, the entire contents of which are incorporated herein by reference.

### FIELD

The present disclosure relates generally to an information processing apparatus, a non-transitory computer-readable medium, and a time period designation system.

### BACKGROUND

Conventionally, a time period of an event or the like may be input in an input screen such as a web page having a data entry section shown on a computer display, a smartphone display, a tablet display, or the like by a web browser communicating with a Web server. A time period may be designated by selecting a start date and an end date from a displayed calendar.

In such time period designation, when the time period is to be designated over a plurality of months, after the start date is designated, multiple operation inputs are often necessary to display the corresponding month or months on an input screen.

Hence, there is a need for an information processing apparatus, an information processing program, and a time period designation system capable of making designation of a time period over a plurality of months easier and more efficient.

### BRIEF DESCRIPTION OF THE DRAWINGS

FIG. 1 depicts a period designation system according to an embodiment.

FIG. 2 depicts a configuration of a server device of a period designation system according to an embodiment.

FIG. 3 depicts a configuration of a terminal of a period designation system according to an embodiment.

FIG. 4 depicts a configuration of a server device and terminal of a time period designating system according to an embodiment.

FIG. 5 depicts an example of a time period input screen according to an embodiment.

FIG. 6 depicts an example of a time period designation screen according to an embodiment.

FIG. 7 depicts an example of a time period designation screen according to an embodiment.

FIG. 8 depicts an example of a time period designation screen according to an embodiment.

### DETAILED DESCRIPTION

According to one or more embodiments, an information processing apparatus includes a processor that displays a first calendar and a second calendar. The processor accepts an operation for designating, as an end date, a date which passes at least three months from a start date designated in the first calendar or the second calendar.

Hereinafter, example embodiments of an information processing apparatus, an information processing program, and a time period designation system will be described with reference to the accompanying drawings. The embodiments described below are non-limiting examples of the information processing apparatus, the information processing program, and the time period designation system, and are not intended to limit configurations, functions, specifications, and the like thereof. The information processing apparatus, the information processing program, and the time period designation system according to the present embodiments are examples of application to a server device that is configured to designate a time period (hereinafter may also be referred to as “period”) of various events, matters, occasions, or the like via an input screen such as a Web page.

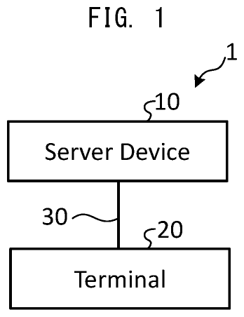

FIG. 1 illustrates an explanatory diagram of an example of a time period designation system 1 (or period designation system) according to one embodiment. The period designation system 1 is a system configured to accept an operation for designating an arbitrary period. The period designation system 1 includes a server device 10 and a terminal 20. The server device 10 and the terminal 20 are communicably connected to each other via a network 30. The period designation system 1 may include a plurality of server devices 10 and a plurality of terminals 20.

In the present embodiment, the server device 10 is a Web server, which is an example of an information processing apparatus. The server device 10 transmits a Web page or the like for designation of a time period to the terminal 20. Once a time period of an event or the like has been input via the web page at the terminal 10, the server device 10 designates the input period as a period of the specific event or the like. The server device 10 may comprise a plurality of server devices and/or a plurality of information processing apparatuses.

The terminal 20 is a device such as a personal computer, a smartphone, a tablet terminal, or the like. The terminal 20 accepts an operation for designating a time period via the Web page transmitted from the server device 10.

Next, example configurations of the server device 10 and the terminal 20 of the period designation system 1 according to one or more embodiments will be described in further detail.

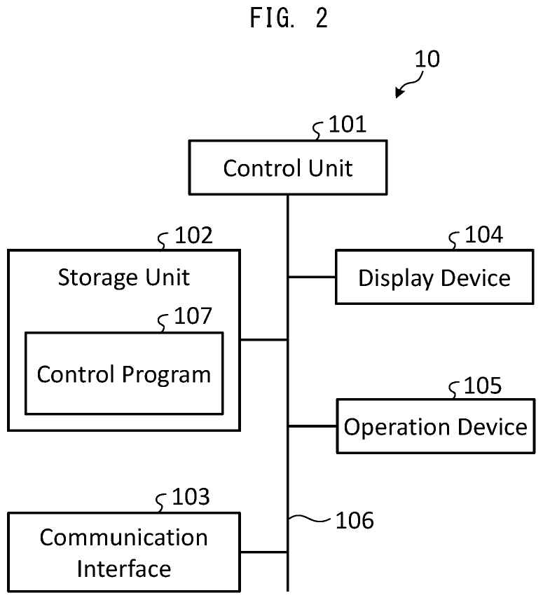

FIG. 2 illustrates a block diagram of an example of a configuration of the server device 10 according to one embodiment. The server device 10 includes a control unit 101, a storage unit 102, a communication interface 103, a display device 104, and an operation device 105. These units are connected to each other via a system bus 106, such as a data bus or an address bus.

The control unit 101 is a computer that controls the overall operation of the server device 10 and implements various functions of the server device 10. The control unit 101 includes a central processing unit (CPU) or a processor, a read only memory (ROM) and a random-access memory (RAM). The CPU controls the operation of the server device 10. The ROM is a storage medium that stores various programs and data. The RAM is a storage medium that temporarily stores various programs and various kinds of data. The CPU executes a program or programs stored in the ROM, the storage unit 102 or the like, utilizing the RAM as a work area.

The storage unit 102 is a storage device such as a hard disk drive (HDD), a solid-state drive (SSD), or the like. The storage unit 102 stores a control program (or a plurality of control programs) 107. The control program 107 is a program that allows an operating system and the server device 10 to perform functions thereof. The control program 107 includes program instructions that when executed perform or otherwise provide the various functions according to the present embodiment.

The communication interface 103 is an interface for communicating with another apparatus via the network 30. For example, the communication interface 103 is configured to communicate with the terminal 20.

The display device 104 is, for example, a display device such as a liquid crystal display. The operation device 105 is, for example, an input device such as a keyboard, a mouse or the like.

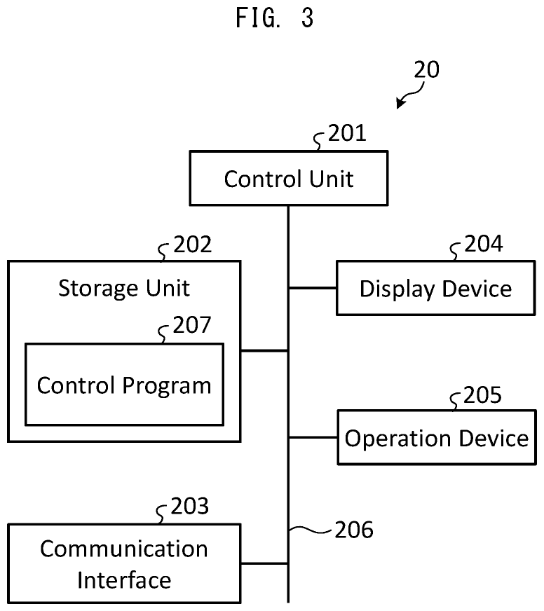

FIG. 3 illustrates a block diagram of an example of a configuration of the terminal 20 according to one embodiment. The terminal 20 includes a control unit 201, a storage unit 202, a communication interface 203, a display device 204, and an operation device 205. These units are connected to each other via a system bus 206, such as a data bus or an address bus.

The control unit 201 is a computer that controls the overall operation of the terminal 20 and implements various functions of the terminal 20. The control unit 201 includes a CPU, a ROM, and a RAM. The CPU controls the operation of the terminal 20. The ROM is a storage medium that stores various programs and data. The RAM is a storage medium that temporarily stores various programs and various kinds of data. The CPU executes a program or programs stored in the ROM, the storage unit 202 or the like, utilizing the RAM as a work area.

The storage unit 202 is a storage device such as an HDD or an SSD. The storage unit 202 stores a control program (or a plurality of control programs) 207. The control program 207 is a program that allows an operating system and the server device to perform functions thereof. The control program 107 includes program instructions that when executed perform or otherwise provide the various functions according to the present embodiment.

The communication interface 203 is an interface for communicating with another apparatus via the network 30. For example, the communication interface 203 is configured to communicate with the server device 10.

The display device 204 is, for example, a display device such as a liquid crystal display. The operation device 205 is, for example, an input device such as a keyboard or a mouse or the like.

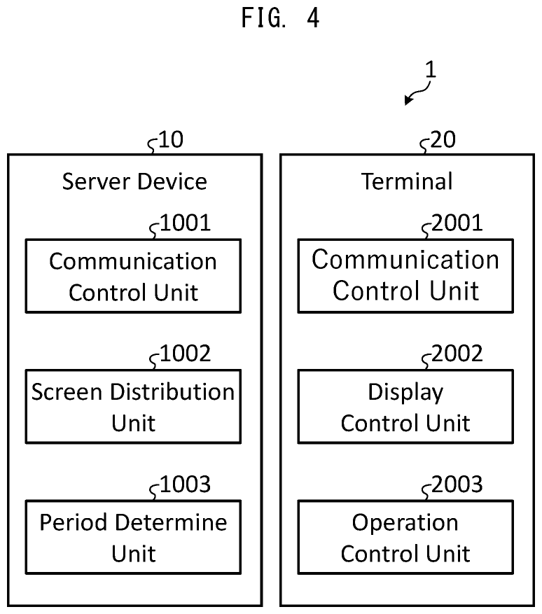

Next, functions of the server device 10 and the terminal 20 of the period designation system 1 will be described in further detail. FIG. 4 illustrates a block diagram of a functional configuration of the server device 10 and terminal 20 of the period designation system 1 according to an embodiment.

The control unit 101 of the server device 10 includes a communication control unit 1001, a screen distribution unit 1002, and a period determination unit 1003 as a functional unit. In one embodiment, the control unit 101 of the server device 10 loads the control program 107 stored in the storage unit 102 into the RAM (see FIG. 2) and operates in accordance with the control program 107 to generate each of the functional units in the RAM.

The communication control unit 1001 controls the communication interface 103 to perform communication with the terminal 20.

The screen distribution unit 1002 functions as a display control unit and an operation control unit. The screen distribution unit 1002 distributes a Web page for designation of a time period to the terminal 20. For example, the screen distribution unit 1002 transmits, via the communication unit 1001, the Web page to the terminal 20 where the web page is displayed on the display device 204 (see FIG. 3) as an input screen to be used for designating the time period. The screen distribution unit 1002 accepts an operation of the time period destination via the terminal 20. In one embodiment, the screen distribution unit 1002 distributes a Web page having a period input screen to the terminal 20.

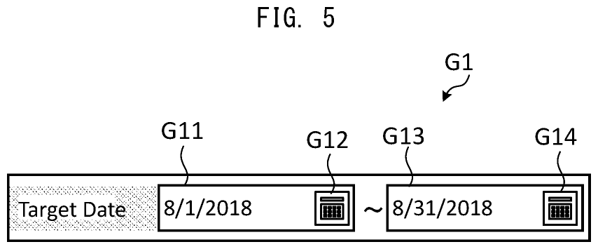

FIG. 5 is a diagram of an example of a period input screen G1. The period input screen G1 includes a start date input field G11, a first calendar icon G12, an end date input field G13, and a second calendar icon G14. The start date input field G11 is an input field for inputting a start date of a target period (or a target date in the example shown in FIG. 5). The first calendar icon G12 is an icon for accepting an operation of displaying a calendar (may also be referred to as a first calendar herein) for designating the start date and the end date of the period. The end date input field G13 is an input field for inputting an end date of the target period. The second calendar icon G14 is an icon for accepting an operation of displaying a calendar (may also be referred to as a second calendar herein) for designating the start date and the end date of the period. The screen distribution unit 1002 permits the input of the end date in the end date input field G13 on the condition that a start date has been input to the start date input field G11. In this case, an operator or a user of the terminal 20 (hereinafter collectively referred to as an operator) can input an end date only after a start date has been input to the start date input field G11.

Once the first calendar icon G12 or the second calendar icon G14 has been selected, the screen distribution unit 1002 distributes a Web page containing a period designation screen to the terminal 20, thereby controlling the terminal 20 to display the first calendar and the second calendar on the display device 204. Then, the screen distribution unit 1002 accepts an operation to designate a date which passes three months from a start date included in the first calendar or the second calendar as an end date.

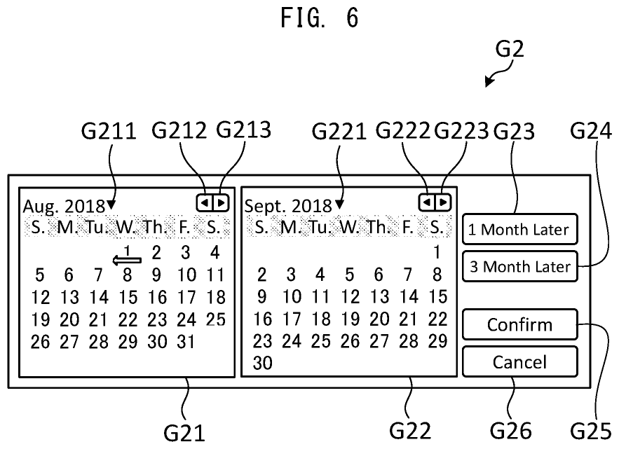

FIGS. 6-8 each illustrate a diagram of an example of a period designation screen G2. The period designation screen G2 includes a first calendar display area G21, a second calendar display area G22, a first period designation button G23, a second period designation button G24, a confirmation button G25, and a cancel button G26.

The first calendar display area G21 is an area where a first calendar is displayed for receiving an input for designating a start date and/or an end date of a target period. The first calendar display area G21 includes a pull-down icon G211, a previous month icon G212, and a following month icon G213. The pull-down icon G211 is an icon for displaying a pull-down for selecting each month. The previous month icon G212 is an icon for accepting an operation for displaying a calendar of the previous month of a month being displayed. The following month icon G213 is an icon for accepting an operation for displaying a calendar of the next month of a month being displayed. When any one of the pull-down icon G211, the previous month icon G212 or the following month icon G213 is selected, the screen distribution unit 1002 controls the terminal 20 to display a calendar of the month corresponding to the first calendar display area G21 on the display device 204.

The second calendar display area G22 is an area where a second calendar is displayed for accepting an input for designating a start date and/or an end date of a target period. When the first calendar icon G12 or the second calendar icon G14 is selected, in an initial state, the screen distribution unit 1002 controls the terminal 20 to display a calendar of the next month of a month being displayed in the first calendar display area G21 in the second calendar display area G22. Here, the initial state is a state in which an end date is not input to the end date input field G13, and an operation to change a month to be displayed in the second calendar display area G22 is not accepted.

In a similar manner to the first calendar display area G21, the second calendar display area G22 includes a pull-down icon G221, a previous month icon G222, and a following month icon G223. The pull-down icon G221 is an icon for displaying a pull-down for selecting each month. The previous month icon G222 is an icon for accepting an operation for displaying a calendar of the previous month of a month being displayed. The following month icon G223 is an icon for accepting an operation for displaying a calendar of the next month of a month being displayed. When any one of the pull-down icon G221, the previous month icon G222 or the following month icon G223 is selected, the screen distribution unit 1002 via the terminal 20 displays a calendar of the month corresponding to the second calendar display area G22 on the display device 204 of the terminal 20.

The first period designation button G23 is a button for designating, as an end date, a date which comes after a certain period indicated on the button. In the example shown in FIGS. 6-8, the first period designation button G23 indicates “1 Month Later” which, when pressed or clicked, designates a date which passes one month from a start date as an end date. The second period designation button G24 is also a button for designating, as an end date, a date after a certain period indicated by the button. In the present example, the second period designation button G24 indicates “3 Months Later” which, when pressed or clicked, designates a date which passes three months from a start date as an end date. That is, the second period designation button G24, when pressed or clicked, accepts an operation of designating, as an end date, a date which comes after the next month being shown in the second calendar display area G22. In the present example, a date in October will be designated as an end date. Accordingly, the second period designation button G24 accepts the operation to designate a date which passes three months from a start date included in the calendar of the first calendar display area G21 or the calendar of the second calendar display area G22 as an end date. In this way, an operator can easily designate an end date after a plurality of months have elapsed from the designated start date, without a need to operate multiple icons such as the previous and following month icons G212, G213, G222, and G223 and to select a desired end date on a specific calendar month. The end date designation by the second period designation button G24 is not limited to the three-month period. A date after four or more months from a start date may be designated as an end date. A date after a further different period may also be designated as an end date. The time period designation by first period designation button G23 and the second period designation button G24 are not limited to monthly units and may be a weekly unit, a daily unit, or a further different unit. The confirmation button G25 is a button for confirming the designation of the period. The cancellation button G26 is a button for cancelling the designation of the period.

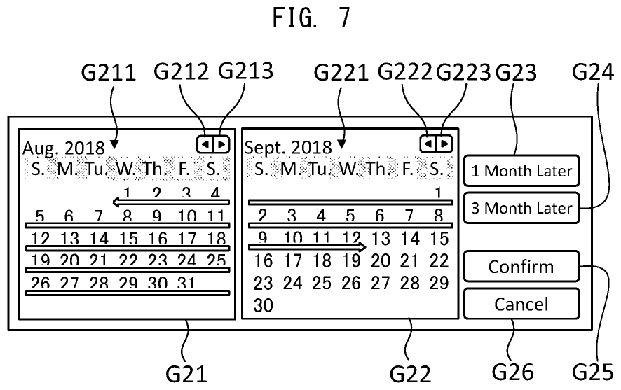

Once the start date and the end date have been designated in the first calendar display area G21 and/or the second calendar display area G22, the screen distribution unit 1002 may have the terminal 20 displaying the date included in the designated period so as to be identifiable by an operator or a user of the terminal 20. For example, as illustrated in FIG. 7, the screen distribution unit 1002 via the display device 204 of the terminal 20 displays the start date by the left arrow and displays the end date by the right arrow. Further, the screen distribution unit 1002 displays the period from the start date to the end date by the bar. The display method of the period is not limited to the display format illustrated in FIG. 7. The time period may be displayed by other formats such as changing colors of the corresponding dates or indicating specific marks on the corresponding dates.

Once the first calendar icon G12 or the second calendar icon G14 has been selected, the screen distribution unit 1002 vis the terminal 20 displays a calendar of the month to which the start date belongs in the first calendar display area G21 on the condition that the start date has been input in the start date input field G11. For example, as shown in FIG. 6, when Aug. 1, 2018 is input as a start date in the start date input field G11 of the period input screen G1, a calendar of August is displayed in the first calendar display area G21 of the period designation screen G2.

The screen distribution unit 1002 via the terminal 20 displays a month to which the start date belongs in the first calendar display area G21 and displays a month to which the end date belongs in the second calendar display area G22 on the condition that the start date has been input to the start date input field G11 and the end date has been input to the end date input field G13. For example, as shown in FIG. 7, when Aug. 1, 2018 is input as a start date in the start date input field G11 of the period input screen G1 and when Sep. 12, 2018 is input as the start date in the end date input field G13 of the period input screen G1, a calendar of August and a calendar of September are displayed in the first calendar display area G21 and the second calendar display area G22 of the period designation screen G2, respectively.

In another embodiment, the screen distribution unit 1002 may make the terminal 20 display a calendar of a month to which today's date belongs in the first calendar area G21 on the condition that the start date has not been input to the start date input field G11. Here, the today's date is a date when the designation of the time period is being performed using the period designation screen G2 shown on the display device 204 of the terminal 20. In still another embodiment, the screen distribution unit 1002 may make the terminal 20 display the following month of a month designated by the first calendar display area G21 in the second calendar display area G22.

If a start date has not been input in the start date input field G11 of the period input screen G1 but instead an arbitrary date has been directly selected on the first calendar display area G21 or the second calendar display area G22 of the period designation screen G2, the screen distribution unit 1002 designates the date selected first on one of the areas G21 and G22 as a start date.

In a further embodiment, when an operation for cancelling the designation of the start date is accepted, the screen distribution unit 1002 cancels the already-designated start date and designates a date that is input or selected after the cancellation as a new start date. The operation of cancelling the designation of the start date may be done by, for example, double-clicking the start date being displayed on the period designation screen G2. It may also be done by selecting cancellation in a general menu bar shown anywhere on the web page or an input screen on the display device 204 of the terminal 20 while the start date to be cancelled is being selected on the period designation screen G2. Further alternatively, in a case where a right click menu containing a cancellation command is displayed when a right button of a computer mouse or mouse pad (that is an example of the operation device 205 of the terminal 20) is clicked, the start date can be cancelled by selecting the cancellation command in the right click menu while the start date to be cancelled is being selected on the period designation screen G2. The operation for cancelling the designation of the start date may be an operation other than the operations described above.

If an end date has been input to the end date input field G13 of the period input screen G1, the screen distribution unit 1002 via the terminal 20 displays a calendar of the month to which the end date belongs in the second calendar display area G22 of the period designation screen G2. On the other hand, if an end date has not been input to the end date input field G13 but instead an arbitrary date has been directly selected on the first calendar display area G21 or the second calendar display area G22 of the period designation screen G2 after the start date has been designated, the screen distribution unit 1002 designates the date selected first on one of the first calendar display area G21 and the second calendar display area G22 as an end date of the target time period.

In a further embodiment, when the screen distribution unit 1002 accepts an operation for cancelling the designation of the end date, the screen distribution unit 1002 cancels the already-designated start date and designates a date that is input or selected after the cancellation as a new end date. The operation to cancel the end date designation may be performed by, for example, double-clicking the end date being displayed on the period designation screen G2 It may also be done by selecting a cancellation command in a general menu bar shown anywhere on the web page or an input screen on the display device 204 of the terminal 20 while the end date to be cancelled is being selected on the period designation screen G2. Further alternatively, in a case where a right click menu containing a cancellation command is displayed when a right button of a computer mouse or mouse pad is clicked, the start date, the start date can be cancelled by selecting the cancellation command in the right click menu in a state while the end date to be cancelled is being selected on the period designation screen G2. The operation for cancelling the designation of the end date may be an operation other than the operations described above.

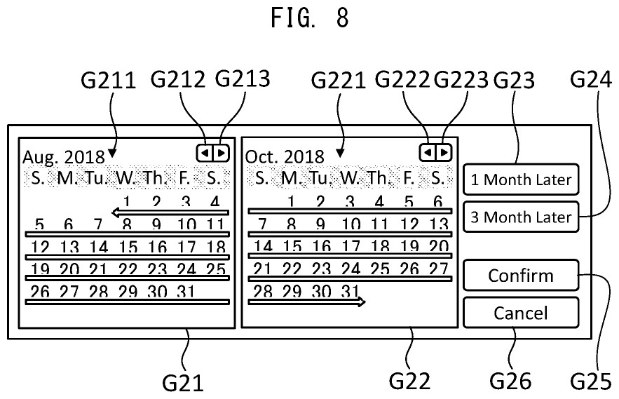

In still another embodiment, when the first period designation button G23 or the second period designation button G24 is selected in a state where the start date has been designated, the screen distribution unit 1002 designates, as the end date, the date which comes after the elapse of the specific period indicated by the first period designation button G23 or the second period designation button G24 from the start date. For example, when the second period designation button G24 is selected in a state where August 1 has been designated as the start date as shown in FIG. 6, the screen distribution unit 1002 designates October 31 as the end date as illustrated in FIG. 8.

In another embodiment, if a start date has not been designated, the screen distribution unit 1002 designates a date which passes three months from today's date as the end date. For example, in a case where the first period designation button G23 or the first period designation button G24 is selected in a state where the start date has not been designated, the screen distribution unit 1002 designates the today's date as the start date and designates, as the end date, the date after the elapse of the period indicated by the second period designation button G23 or the second period designation button G24 from the today's. Accordingly, if an operator of the terminal 20 desires to select a period starting from today's date, the operator can designate the end date only by using the first period designation button G23 or the second period designation button G24, that is without the operation of designating the start date.

In another embodiment, when the first period designation button G23 or the second period designation button G24 accepts the operation of designating the end date, the screen distribution unit 1002 via the terminal 20 displays the start date in the calendar of the first calendar display area G21 and displays the end date in the calendar of the second calendar display area G22. For example, as illustrated in FIG. 8, the screen distribution unit 1002 via the terminal 20 displays a calendar to which August 1 as a start date belongs in the first calendar display area G21 and display a calendar to which October 31 as an end date belongs in the second calendar display area G22. Accordingly, an operator of the terminal 20 can see the start date and the end date on the display device 204 at once.

When an end date is designated by the first period designation button G23 or the second period designation button G24, the screen distribution unit 1002 makes the terminal 20 display a calendar of the month to which the end date belongs, that is, the calendar of the month after the elapse of the period designated by the first period designation button G23 or the second period designation button G24 in the second calendar display area G22. Therefore, an operator can easily operate the terminal 20 to display a calendar of the month after the elapse of the period designated by the first period designation button G23 or the second period designation button G24 by selecting the first period designating button G23 or the second period designating button G24 in the time period designation screen G2 displayed on the display device 204 of the terminal 20.

In a further embodiment, the screen distribution unit 1002 may designate, as the end date, a first designated date, which is after the present end date. The first designated date can be designated by the first period designation button G23 or the second period designation button G24. In this case, for example, the screen distribution unit 1002 controls the terminal 20 to display the first designated date after this date has been designated by the first period designation button G23 or the second period designation button G24 as the end date. Therefore, an operator can easily designate some date that belongs to a month after the period previously designated by using the first period designation button G23 or the second period designation button G24.

When the confirmation button G25 is pressed, the period determination unit 1003 of the server device 10 determines the period designated on the period designation screen G2 as the time period of the event or the like.

Referring back to FIGS. 3 and 4, the control unit 201 of the terminal 20 loads the control program 207 stored in the storage unit 202 to the RAM and operates in accordance with the control program 207, thereby generating each functional unit in the RAM (see FIG. 3). The control unit 201 of the terminal 20 includes a communication control unit 2001, a display control unit 2002, and an operation control unit 2003 as functional units (see FIG. 4).

The communication control unit 2001 controls the communication interface 203 to execute communication with the server device 10.

The display control unit 2002 controls the display device 204 of the terminal 20 to display various screens to be displayed thereon. For example, the display control unit 2002 have the terminal 20 displaying a Web page, which the communication control unit 2001 received from the server device 10, on the display device 204. Within the web page, the period input screen G1 and the period designation screen G2 will be displayed.

The operation control unit 2003 controls the operation device 205 of the terminal 20 to accept various kinds of operation. For example, the operation control unit 2003 accepts an operation for designating a time period including an start date and an end date on the period input screen G1 and the period designation screen G2, which have been displayed on the display device 204 of the terminal 20 by the display control unit 2002.

As described above, the server device 10 according to the present embodiments controls the terminal 20 to display the period designation screen G2 having the first calendar display area G21 and the second calendar display area G22 shown within an input screen such as a web page displayed on a display device, such as a computer display, smartphone display, or a tablet display, of the terminal 20. Further, the server device 10 accepts an operation for designating a date which passes three months from a start date as an end date by the second period designation button G24. Therefore, the server device 10 can easily have the time period designated via a simple operation at the terminal 20 by its operator or user.

While the embodiments where the information processing apparatus is applied to the server device 10 have been described, all or a part of the functions of the server device 10 may be included in the terminal 20 in other embodiments. For example, one or more of the communication control unit 1001, the screen distribution unit 1002, and the period determination unit 1003 shown in FIG. 4 may be included in the terminal 20. Alternatively, the server device 10 and the terminal 20 may cooperate with each other to realize the various functions.

While the programs executed by the devices according to the embodiments and examples may be incorporated in advance in the storage medium (ROM or storage unit) included in each device, the present disclosure is not limited thereto. For example, the programs may be recorded in a computer-readable recording medium such as a CD-ROM, a flexible disk (FD), a CD-R, or a digital versatile disk (DVD) in a file in an installable format or an executable format. Such programs are read and executed by a CPU or a processor of the respective devices such as the server device 10 and the terminal 20 of the period designation system 1. The storage medium is not limited to a medium that is independent of the computer or the embedded system. The storage medium may be a medium that stores or temporarily stores the programs by downloading such programs transmitted via LAN, Internet, or the like.

The programs executed by the respective devices according to the embodiments and examples may be stored in a computer connected to a network such as the Internet and may be provided to the devices such as the server device 10 and the terminal 20 by being downloaded via the network from such a computer. Alternatively, the programs may be provided or distributed via a network such as the Internet.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a processor configured to:
display a first calendar and a second calendar; and
accept an operation for designating, as an end date, a date which is at least three months after a start date designated in the first calendar or the second calendar.

2. The information processing apparatus according to claim 1, wherein the processor is further configured to display a first designated date as the end date after a previously designated end date has been displayed.

3. The information processing apparatus according to claim 1, wherein the processor is further configured to display the start date and the end date in the first calendar and the second calendar, respectively, when the processor accepts the operation for designating the end date.

4. The information processing apparatus according to claim 1, wherein the processor is further configured to designate a date which is at least three months from a current date as the end date if the start date is not designated.

5. The information processing apparatus according to claim 1, wherein the information processing apparatus is a server device configured to be communicably connected to a terminal via a network and to control the terminal to display the first calendar and the second calendar.

6. The information processing apparatus according to claim 5, wherein the processor is further configured to transmit a web page to the terminal to display a time period designation screen that contains a first calendar display area and a second calendar display area.

7. The information processing apparatus according to claim 6, wherein the time period designation screen includes a button to designate a three-month period from the start date or today's date.

8. The information processing apparatus according to claim 7, wherein, when the button is selected, the processor designates a date which passes the three-month period from the start date or a current date as the end date.

9. A non-transitory computer-readable medium storing a program which when executed causes a computer to perform a process comprising:
displaying a first calendar and a second calendar; and
accepting an operation for designating, as an end date, a date which is at least three months after a start date included in the first calendar or the second calendar.

10. The non-transitory computer-readable medium according to claim 9, the process further comprising:
displaying a first designated date after the end date after a previously designated as the end date has been displayed.

11. The non-transitory computer-readable medium according to claim 9, the process further comprising:
displaying the start date and the end date in the first calendar and the second calendar, respectively, when the operation for designating the end date is accepted.

12. The non-transitory computer-readable medium according to claim 9, the process further comprising:
designating a date which is at least three months from a current date as the end date if the start date is not designated.

13. The non-transitory computer-readable medium according to claim 9, the process further comprising:
controlling a terminal provided on a network to display the first calendar and the second calendar.

14. The non-transitory computer-readable medium according to claim 13, the process further comprising:
transmitting a web page to the terminal via the network to display a time period designation screen that contains a first calendar display area and a second calendar display area.

15. The non-transitory computer-readable medium according to claim 14, wherein
the time period designation screen includes a button to designate a three-month period from the start date or the current date, and
when the button is selected, a date which is after the three-month period from the start date or current date is designated as the end date.

16. A period designation system, comprising a server device communicably coupled to a terminal via a network, the server device comprising a processor configured to:
control the terminal to display a first calendar and a second calendar; and
accept an operation via the terminal for designating, as an end date, a date which is at least three months after a start date included in the first calendar or the second calendar.

17. The period designation system according to claim 16, wherein the processor is further configured to control the terminal to display a first designated date after a previously designated end date has been displayed on the terminal.

18. The period designation system according to claim 16, wherein the processor of the server device is further configured to control the terminal to display the start date and the end date in the first calendar and the second calendar, respectively, when the processor accepts the operation for designating the end date.

19. The period designation system according to claim 16, wherein the processor of the server device is further configured to designate a date which is at least three months after a current date as the end date if the start date is not designated.

20. The period designation system according to claim 16, wherein the processor of the server device is further configured to transmit a web page to the terminal to display a time period designation screen that includes a first calendar display area, a second calendar display area, and a button to designate a three-month period from the start date or the current date.
